(19) United States
(12) Patent Application Publication
(10) Pub. No.: US 2004/0162908 A1
(43) Pub. Date: Aug. 19, 2004

(54) Method of servicing reception of software broadcasted in a carousel of objects

(76) Inventor: Pawel Wrobel, Katowice (PL)

Correspondence Address: WILLIAM COLLARD, COLLARD & ROE, P.C., 1077 NORTHERN BOULEVARD, ROSLYN, NY, 11576, US

(21) Appl. No.: 10/775,581

(22) Filed: Feb. 10, 2004

(30) Foreign Application Priority Data
Feb. 10, 2003 (PL) P358659

(51) Int. Cl. G06F 15/16

(52) U.S. Cl. 709/230

(57) ABSTRACT

The presented method allows capturing information broadcasted cyclically in the carousel of objects and creating a file system, which is later used by applications, operating for example under control of MHP system. The method is characterized in that from the moment of connecting the receiver to the data stream, the data belonging to the defined carousel are retrieved, in the sequence of broadcast of these data in the stream. After receiving all data, modules are created out of them. These modules are decompressed, and next their content is appended to the file system of the receiver.

### CROSS-REFERENCE TO RELATED APPLICATIONS

This application claims priority to Polish Application No. P-358659, filed Feb. 10, 2003, the contents of which are incorporated herein by reference.

### BACKGROUND OF THE INVENTION

1. Field of the Invention

The present invention relates to a method of reception of software broadcasted in a carousel of objects.

2. Brief Description of the Background of the Invention Including Prior Art

A method of updating software broadcasted in a carousel of objects is known from an MHP (Multimedia Home Platform) system. In that method, data is exchanged only on a specific request, i.e. when an application refers to a module that is missing. Then, the system searches the object carousel for the requested module. Such a method is very time-consuming.

The method of managing data of a carousel of objects, which is known from the US patent application publication no. US 2002/0059645 assumes introduction of modification at the side of the transmitter. The writing of objects broadcasted in the carousel is conducted at the level of application modules, while the version of the module and time, during which the given module is valid are stored in the device. Additionally if versions of modules change, all versions and time of their validity are stored in the module. The requirement of modifying the data stream at the side of the transmitter and accumulating excessive information in a receiver makes this way a very complicated one, and thus time consuming and inconvenient in use.

### SUMMARY OF THE INVENTION

Purposes of the Invention

It is the object of the present invention to provide a method, which allows capturing information broadcasted cyclically in a carousel of objects and creating a file system, which is later used by applications, operating for example under the control of the MHP system.

The advantage of the present invention lies in that the carousel objects reception time is significantly reduced. Another advantage is that the method can be implemented in all existing objects carousel receivers with minimum effort. These and other objects and advantages of the present invention will become apparent from the detailed description, which follows.

Brief Description of the Invention

In accordance with the method of the present invention, from the moment of connecting a receiver to the data stream, in which software is broadcasted in the form of a carousel of objects, data belonging to this carousel are retrieved in the sequence in which they are broadcasted in the stream and not in line with the modules or modules content sequence. After all data are received, modules are created out of them. These modules are decompressed, and next their content is appended to the file system of the receiver.

When a section of a packet including carousel modules is retrieved from the data stream packets, it is checked if the section includes required data, which are stored in the storage of the receiver while completeness of the retrieved carousel of objects is checked.

The data sections, retrieved from the data stream, which are associated with a specific carousel of objects, are broadcasted in packets with a specific PID number.

The receiver gets connected to the data stream when an application of the receiver executes a request, which defines the PID number of packets, in which the carousel of objects requested by the application is broadcasted.

The receiver also gets connected to the data stream in a case, when an applications manager attempts to start an application, which is signaled in a given service together with a PID number of packets, in which the carousel of objects of the signaled application is broadcasted.

The presented method allows capturing information broadcasted cyclically in a carousel of objects and creating a file system, which is later used by applications, operating for example under control of MHP system. However, the data modules are not retrieved only when the application refers to the missing module, but also immediately after finding a change of data broadcasted in the carousel of objects. The solution does not require any modifications of the data stream at the side of the transmitter and acts without additional information related to validity of the broadcasted modules. Moreover, only the most recent version (i.e. identifier) of the module and the module itself are stored in a receiver.

The novel features, which are considered as characteristic for the invention are set forth in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

Advantages and features of the invention will become apparent from the following description thereof taken in conjunction with the accompanying drawings that illustrate a specific embodiment of the invention. In the drawings:

FIG. 1—presents the method of receiving the program known from the prior art,

FIG. 2—presents the method of receiving the program according to the invention,

FIG. 3—presents the method of organizing file system by means of modules,

FIG. 4—presents a comparison of the time of data retrieving performed according to the known method and the method of the invention,

FIG. 5—presents the use of the method in case certain modules were not retrieved earlier.

### DESCRIPTION OF INVENTION AND PREFERRED EMBODIMENT

The broadcaster sends software together with an audio/video signal in one data stream. A receiver, which can be a digital television decoder (also called an Integrated Receiver Decoder (IRD) or a set-top box), receives the software, which is next stored in the memory of a receiver, and subsequently manually started in the receiver. Such exemplary software can be an EPG—Electronic Program Guide, games or news services. According to the prior art, applications are broadcasted in form of modules in the carousel of objects, where data and the software code are broadcasted cyclically. Such solution resembles the teletext system, in which pages are broadcasted in cycles.

The exemplary system, in which transmission in the television data stream takes place, is known from international standard ISO/IEC 13818-6—MPEG-2 Digital Storage Media Command and Control (DSM-CC). The MPEG stream includes multiplexed television channels. Any such television channel can include interactive applications designated to a receiver.

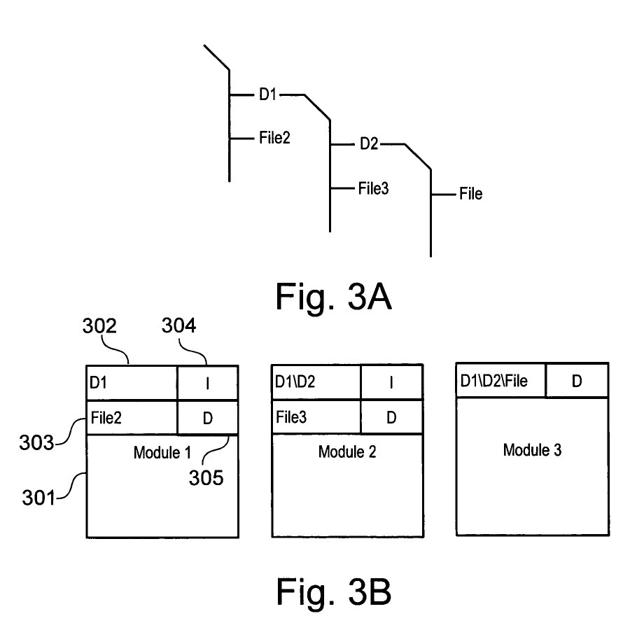

Objects, which are sent by means of DSM-CC protocol, are a part of a carousel of objects. They are broadcasted in the form of modules, which create a system of objects, files. The organization of the system of files stored at the side of a receiver is similar to the system, known from standard PC computers. When a receiver, for example, a digital television decoder needs to retrieve an object from a carousel of objects, it must know, in which module the given object is located. After appropriate module is retrieved by a receiver, the module is analyzed in order to find the right object. Organization of modules is presented in FIG. 3B, where three modules include a system of files described in FIG. 3A. Each module 301 can include files 303 and directories 302. If the module includes a file, it must also include its content 305, while in case of a directory, the module includes information 304 about files/directories, which are located in it. This information includes the name of the file/directory and, among others, information about the module, in which this file/directory is broadcasted.

Due to the hierarchy of objects broadcasted in the carousel, the given object can be located in one of sub-directories. In such case, in order to find the object, a receiver must also collect all superior modules in relation to the module storing the object, which must be analyzed before a receiver reads the appropriate object. For example, if a receiver needs to retrieve the object “File” located in path “D1/D2/File”, it must check first in which module the object “D1” is broadcasted, next retrieve the object “D1”, read in which module the object “D2” is broadcasted, possibly retrieve this module, and subsequently read from the object “D2”, in which module the object “File” is broadcasted. In the simplest case, all three objects can be in one module and then it is enough to retrieve only this single module. In the most complicated case, which is illustrated in FIG. 3B, each of these objects is in a different module. In order to check if the path is correct and the object “File” exists, all three modules must be retrieved from the data stream.

Most frequently the carousel of objects is sent in a compressed form. Compression is added at the level of modules. As a result a receiver has additional difficulty, which is the requirement of decompressing all the modules required to find the objects, which at a given time are required by a receiver. A single module includes usually many objects, which are compressed as a whole. Such system, considering a possibility of data processing in receivers, like for example digital television receivers, is time consuming and demands high system resources.

Additional hindrance is the fact that files and directories of the system of the carousel of objects can change in time. In the DSM-CC data transmission system the version is defined only at the level of modules, and not at the level of the hierarchy of directories or the objects themselves. In case only one object from the module changes, the whole module will receive a new version and must be once again retrieved as a whole from the carousel of objects.

Another impediment is the fact that objects can be shifted among separate modules. They can also be added or removed. Such situation leads to quite frequent exchanges of objects, which constitute a part of the software of a receiver, such as for example digital television decoder. In the presented method the object with changed location will be retrieved faster.

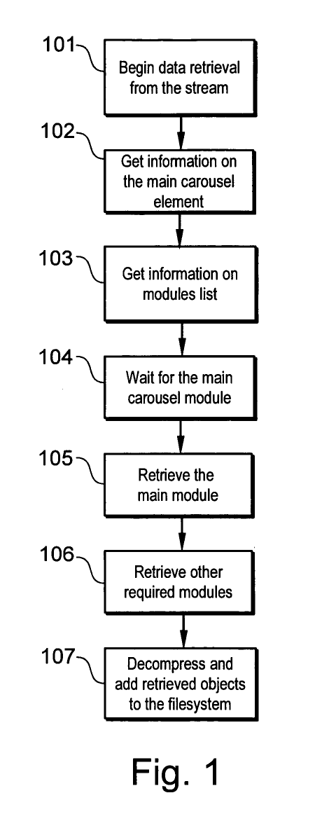

According to the typical method of data reception, in order to append the carousel of objects to the file system of a receiver, typically digital television receiver, first the module with the main element of the carousel should be retrieved. Next the consecutive modules are retrieved, depending on what objects are needed by the application. The typical algorithm of data retrieving is illustrated in FIG. 1. After connecting to the data stream 101, information about the main module (root) is retrieved in point 102 of the procedure. Next information about the list of modules, broadcasted in the carousel 103, is retrieved. After analyzing this information one should wait by the time when the main module (root) 104 is broadcasted. The next point is to retrieve the main module (root) of the carousel of objects 105. The next step of the procedure is to read other modules 106 needed by the application. The last task of the procedure is to place the retrieved objects in the file system 107, which is written in the storage of the receiver (usually it is a Flash type memory), for example a decoder of digital television.

In order to define the time needed for correct retrieving of the update for the application, which includes five modules, the following calculations should be made:

It is assumed that retrieving information about the main module (root) of the carousel lasts for time t_root,

It is assumed that the average time of waiting for information about the module (root) of carousel lasts for time t_root_wait,

It is assumed that retrieving information about the lists of modules lasts for time t_list,

It is assumed that the average waiting time for information about the list of modules lasts t_list_wait,

It is assumed that retrieving one module lasts time t_module,

It is assumed that the average waiting time before the module starts to be broadcasted is t_module_wait.

In case, when the application needs N modules for operation, the total time of retrieving the modules for this application is:

t_{—}root+t_{—}root_{—}wait+t_{—}list+t_{—}list_{—}wait+N * (t_{—}module_{—}wait+t_{—}module)

It is assumed in the proposed method that in most cases the application needs all the modules, which are broadcasted in the carousel of objects. Moreover the carousel is broadcasted cyclically, without longer delays between its end and beginning.

Since the application usually needs all the modules from the carousel of objects, it is not favorable to wait until the moment when the program refers to the nonexistent module in the system, but all modules should be retrieved at once. In such case one eliminates the waiting time for separate information, and all the modules start to be retrieved immediately from the moment of connecting the receiver to the data stream. Instead of retrieving the broadcasted modules in appropriate sequence, all modules are retrieved in the sequence, in which they are broadcasted in the carousel of objects. It is expected that these are correct data and information about them will be broadcasted very soon. Therefore, it may happen that first the modules will be retrieved from the stream and next the information about them will be retrieved. The time of retrieving the same application, assuming that there are N modules in the carousel, is: N * t_module.

Therefore the average time gained is:

t_{—}root+t_{—}root_{—}wait+t_{—}list+t_{—}list_{—}wait+N * t_{—}module_{—}wait

Information about the list of modules and the main module (root) is broadcasted between modules with a much higher frequency, thus when calculating the time of retrieving application, using the method according to the invention, one does not have to add times t_root_wait+t_list_wait+t_list. However, in certain cases the method, according to the invention, might have worse results regarding the time of retrieving the modules. For example, in case when there are many modules in the carousel and the application needs only one.

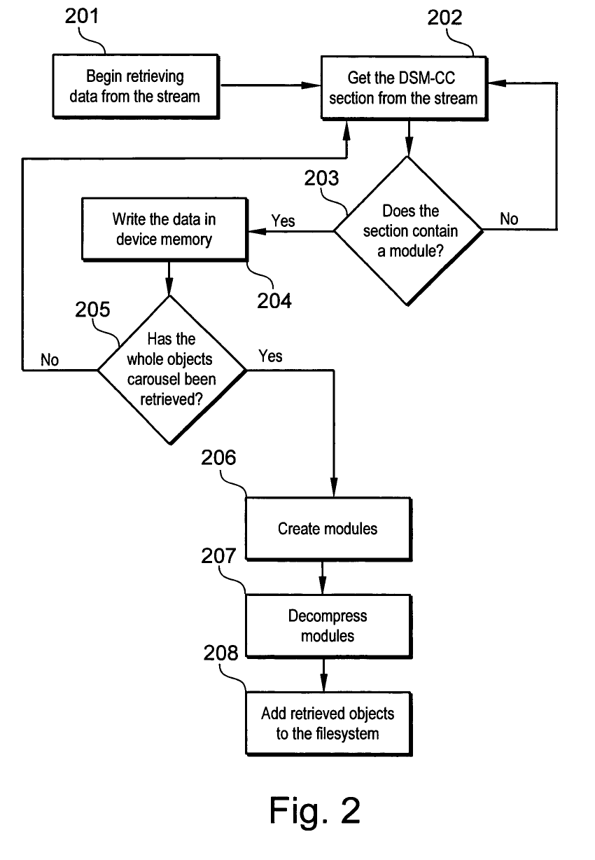

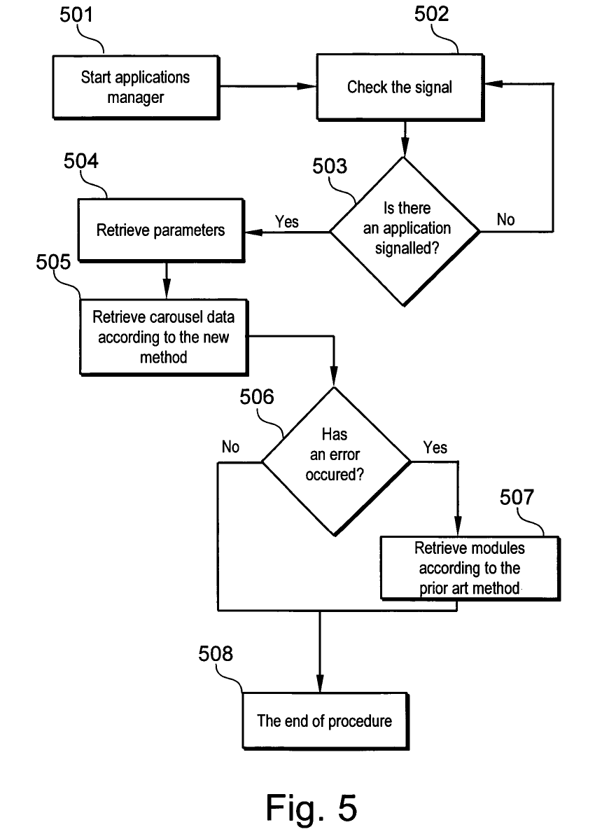

There is also risk that a few of the modules will not be retrieved earlier and in such case the other required modules are retrieved according to the typical method. Such situation was presented in FIG. 5. In point 501 applications manager, managing the programs of a given receiver is started. After the start, the data sent in the stream, for example MPEG2 format data, are monitored 502. It is checked sequentially if the signaled application 503 is in the stream. If there is not such signal, the data sent in the stream are monitored further. In opposite case, information defining the parameters of the application, broadcasted in the application 504 stream, is retrieved. The next step of the procedure 505 is to retrieve the carousel of objects, according to the method shown in FIG. 2. If during retrieving the data an error 506 occurs, the modules are retrieved in the step 507 from the carousel according to the known methods—FIG. 1. Errors include situations when the receiver has too low memory to write the whole carousel of objects. Other problems are, for example: a decrease of the signal quality or a situation when during retrieving a given module its version changes.

Data retrieving is performed continually by the time when the receiver finds that all data from the carousel broadcasted in the stream packets with a specific PID number were already retrieved. PID number is defined by application, which requires data reading from the carousel, broadcasted in the elementary stream packets with a specific PID number. Continual retrieving is understood in such a way that a filter of section DSM-CC of MPEG2 packets is activated thus it passes all possible data connected with the carousel broadcasted in the packets with a specific PID number. Only later, modules and other information are compiled from the retrieved data. If data were to be retrieved module by module, the filter would have to be set to consecutive modules, and next it would have to be switched off and switched on again, in order to retrieve the next module. During the time when the filter is turned off, the module, which was to be retrieved, can already be broadcasted, which would result in waiting for the next broadcast of the carousel of objects. Additionally, because the sequence of broadcasting modules is not known there is never a certainty that they would be retrieved in appropriate, optimum sequence. The method, according to the invention, eliminates these problems and the losses of time, thanks to retrieving all data sections, as they are broadcasted in the carousel. Next their real content is checked. The method of retrieving data from the stream, for example in MPEG-2 format was illustrated in FIG. 2. The procedure starts with the time of connecting to the data stream 201, which may be a result of a request from the side of the application. Next, sections DSM-CC are retrieved from packets with a specific PID number 202. The next stage 203 is to check if the retrieved data section includes the module. If this is a fact, a shift to point 204 of the procedure is made. Otherwise a return to point 202 is made, where the next section from the stream is received. In the place marked with number 204 data are stored in the memory of the receiver. Next it is checked if all data sections 205, broadcasted in the carousel of objects with the use of protocol DSM-CC, were already retrieved. If not, the procedure returns to point 202. In opposite case, modules will be created from the retrieved data 206. The next step is decompression of modules 207, so that appropriate objects broadcasted in the carousel are received in effect. The last task of the procedure is to place the retrieved objects in the file system 208, which is written in the memory of the receiver—usually this is a FLASH type memory, for example a digital television decoder.

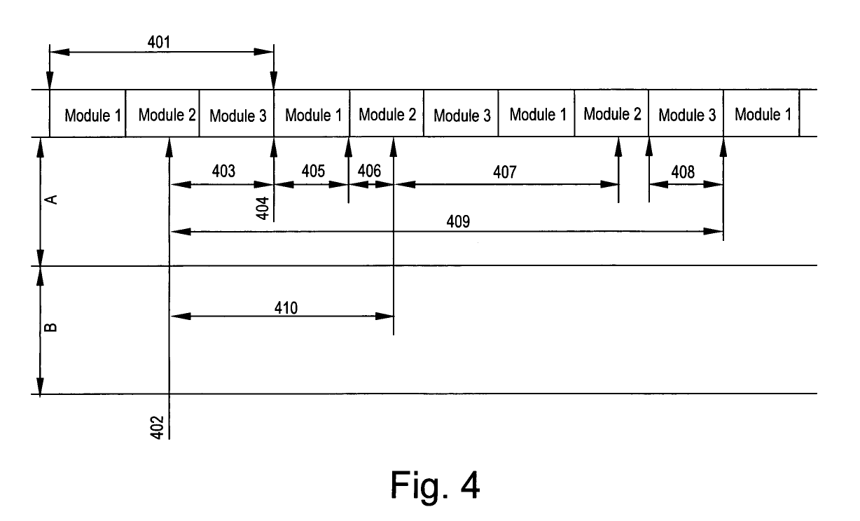

As practical tests show, the method according to the invention guarantees on average a twice-faster delivery of the new module to the application operating in the receiver, for example a digital television decoder. An exemplary comparison of the time needed to retrieve the carousel of objects consisting of three modules was illustrated in FIG. 4. Part A shows the method known from the state of technology, while part B—the method according to the invention. One cycle of the carousel of objects was marked with a number 402. Proceeding in line with the method A, one should wait until the main module (root) appears in the stream, marked with symbol “Module 1”. This time is marked with a number 403. In point 404 retrieving of the main module starts, which lasts for the time, defined with the number 405. The time 406 means a delay resulting from analysis of the main module by the application. Due to this delay, retrieving of the second module starts already when a part of “Module 2” is broadcasted. That is why in order to retrieve the rest of “Module 2” one should wait until it is broadcasted once again. The time of retrieving “Module 2” is defined by the range 407. “Module 3” is retrieved as the last one, in the time indicated with a number 408. The whole operation of retrieving the three modules, according to the known method, lasts for the time marked with the number 409. According to the invention, the modules are retrieved from the stream one by one, as they are broadcasted. Immediately after connecting to the data stream, modules are retrieved by the time when all the modules are retrieved. The whole operation occurs in the time marked as 410. Only later they are analyzed. Thanks to that, the time needed to update the data is reduced to the indispensable minimum and a much shorter start-up time is ensured for the applications operating in the receiver, in case they need an exchange of modules. Since, in majority of cases the module will be updated before the program refers to it.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. The method of handling reception of receiver software, according to which the software is broadcasted in the data stream, in the form of the carousel of objects, while after reception and decompression, the software is written in the receiver storage, characterized in that from the moment of connecting the receiver to the data stream, the data belonging to the defined carousel are immediately retrieved, using a packets filter, in the sequence of broadcast of these data in the stream, after receiving all data, modules are created out of them and these modules are decompressed, and next their content is placed in the file system of the receiver.

2. The method, according to claim 1, characterized in that, from the packet of the data stream a section of the packet is retrieved, which includes the module of the carousel, next it is checked if the section includes the needed data, which are written in the storage of the receiver, at the same time the completeness of the retrieved carousel of objects is checked.

3. The method, according to claim 1, characterized in that the data sections, retrieved from the data stream, related to the defined carousel of objects, are broadcasted in packets with a specific PID number.

4. The method, according to claim 3, characterized in that the receiver gets connected to the data stream when an application of the receiver executes a request, which defines the PID number of packets, in which the carousel of objects requested by the application is broadcasted.

5. The method, according to claim 4, characterized in that the receiver gets connected to the data stream in case when the applications manager attempts to start the application, which is signaled in a given service together with the PID number of packets, in which the carousel of objects of the signaled application is broadcasted.
